(19) United States
(12) Patent Application Publication
(10) Pub. No.: US 2010/0076941 A1
(43) Pub. Date: Mar. 25, 2010

(54) MATRIX-BASED SCANS ON PARALLEL PROCESSORS

(75) Inventors: Yuri Dotsenko, Redmond, WA (US); Naga Govindaraju, Redmond, WA (US); Charles Boyd, Redmond, WA (US); John Manferdelli, Redmond, WA (US); Peter-Pike Sloan, Salt Lake City, UT (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/206,758

(22) Filed: Sep. 9, 2008

(51) Int. Cl. G06F 17/30

(52) U.S. Cl. 707/705; 707/E17.005

(57) ABSTRACT

A system and method for performing a scan of an input sequence in a parallel processor having a shared register file. A two dimensional matrix is generated, having a number of rows representing a number of threads and a number of columns based on the input sequence block size and the number of rows. One or more padding columns may be added to the matrix to avoid or reduce memory bank conflicts. A first traversal of the rows performs a reduction or a scan of each of the rows in parallel, storing the reduction values. The reduction values are used during a second traversal to propagate the reduction values. In a segmented scan, propagation is selectively performed based on flags representing segment boundaries.

### TECHNICAL FIELD

The present invention relates generally to computer systems, and, more particularly, to parallel processing on computers having parallel processing units.

### BACKGROUND

Parallel processors are programmable processors with high memory bandwidth and high parallelism. Graphics processing units (GPUs) are one type of parallel processor, with features to facilitate graphic operations, gaming applications, or other media applications, as well as other applications that may be facilitated by highly parallel operations. GPUs typically support data-parallel algorithms such as scan algorithms that exploit the high memory bandwidth and parallelism of GPUs. In a paper titled “Prefix Sums and Their Applications,” Guy Blelloch discussed scan techniques and applications thereof.

A scan primitive, also known as a “prefix-sum,” is defined such that for an input sequence A=[a₀, a₁, a₂ . . . , aₙ₋₁] of n elements, and a binary associative operation ⊕ with left identity ε_{⊕}, the inclusive scan primitive transforms A into output sequence B=[a₀, a₀⊕a₁, a₀⊕a₁⊕a₂, . . . , a₀⊕a₁⊕a₂ . . . ⊕aₙ₋₁]. The exclusive scan primitive transforms A into output sequence [ε_{⊕}, a₀, a₀⊕a₁, a₀⊕a₁⊕a₂, . . . , a₀⊕a₁⊕a₂ . . . ⊕aₙ₋₂]. For example, if the operation ⊕ is addition, with identity ε_{⊕}=0, and input A=[1, 7, −4, 2, 2, −1, 5], the inclusive scan(A)=[1, 8, 4, 6, 8, 7, 12] and the exclusive scan(A)=[0, 1, 8, 4, 6, 8, 7]. In the exclusive scan, each element of the output vector is the sum of all values that precede it in the input vector. In the inclusive scan, each element of the output vector is the sum of the corresponding input element and all values that precede it in the input vector. These scans are forward scans. Backward scan primitives are similar to the corresponding forward scans, but traverse the input sequence in a reverse direction. The exclusive backward scan of the input A above is [0, 5, 4, 6, 8, 4, 11]. Examples of other left associative binary operations are multiplication, minimum, and maximum operations.

Multiple input sequences, referred to herein as segments, may be scanned concurrently by concatenating them together into a single input vector and providing a second vector that identifies the original segments. The second vector is used to indicate locations where preceding values are not to be propagated. This is referred to as a segmented scan. For example, such an identifying vector may be a vector of head-flags, where a set flag denotes the first element of a new segment. An example of a segmented scan using a vector of head-flags follows:

Input segments: [1, 7], [−4], [2, 2, −1, 5]

Combined input vector: [1, 7, −4, 2, 2, −1, 5]

Flags vector: [1,0, 1, 1, 0, 0, 0]

Exclusive forward scan: [0, 1, 0, 0, 2, 4, 3]

Inclusive forward scan: [1, 8, −4, 2, 4, 3, 8]

Exclusive backward scan: [0, 5, 4, 6, 0, 0, 7]

Scans may be used in a variety of applications. A brief list of example applications include:

Lexical comparison of strings;

Addition of multi-precision numbers;

Polynomial evaluation;

Solving recurrences;

Implementation of sort algorithms, such as radix sort and quicksort;

Searching for regular expressions;

Histograms; and

Sparse vector matrix multiplication.

There exist several ways of performing scan operations on parallel processors. It is advantageous to have techniques for performing scans that improve performance or efficiency of scan operations.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Briefly, a system, method, and components operate to perform scans on GPUs or other parallel processors. Data is represented in a manner that optimizes mapping into the architecture of a GPU. Mechanisms structure and operate on data in a way to minimize memory bank conflicts and reduce latency of memory accesses. The mechanisms may be applied to forward or backward segmented or unsegmented scans, with a variety of operators and data types.

A system may include a parallel processor having a shared register file divided into N banks of memory, multiple scalar processors that execute multiple threads, each thread accessing the shared register file.

The system may further include a scan kernel that includes program instructions for performing a scan on an input sequence. This may include subdividing the input sequence into blocks of length B that can be processed within the shared register file, and determining dimensions of a two-dimensional padded matrix, in which a matrix height H represents a thread grouping. A data matrix width W may be determined by dividing H into B. A pad length P may be determined such that (W×sizeOfElement)+P is relatively prime with the number of memory banks, where sizeOfElement is the number of banks occupied by an element of the input sequence in the shared register file, and P is in memory bank units. In one embodiment, H is equal to the number of threads that perform parallel reductions or scans along the rows of the matrix. In one aspect of the system, H is determined so that it is the warp size, or a numeric multiple thereof, or at least approximately equal to a numeric multiple of the warp size.

In one aspect of the system, a padded matrix is generated having dimensions H and (W×sizeOfElement)+P, so that each row of the padded matrix has W elements of the input sequence block and occupies (W×sizeOfElement)+P) consecutive units of the shared register file.

One aspect of the system includes using threads of a thread group to perform, in parallel, a traversal of each of the rows of the matrix, determining a reduction value of each row based on the row elements and an operator. The reduction values may be stored in an auxiliary array in the shared register file.

Another aspect of the system includes using the threads to perform a second traversal of each of the rows, selectively propagating the reduction value of an immediately preceding row. Mechanisms of the system may include performing a scan of the array of reduction values prior to performing the second traversal. The array scan may use multiple threads, and may itself use mechanisms of a matrix scan.

In one aspect of the system, the input sequence includes multiple segments, and a vector of flags may be used to indicate boundaries of the segments. The flags may be used to determine whether to propagate reduction values, based on the location of the segmentation boundaries.

In one aspect of the system, the threads may be synchronized after performing the first traversal. A second synchronization may be performed prior to performing the second traversal. Synchronization is not needed during the traversals.

To the accomplishment of the foregoing and related ends, certain illustrative aspects of the invention are described herein in connection with the following description and the annexed drawings. These aspects are indicative, however, of but a few of the various ways in which the principles of the invention may be employed and the present invention is intended to include all such aspects and their equivalents. Other advantages and novel features of the invention may become apparent from the following detailed description of the invention when considered in conjunction with the drawings.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

To assist in understanding the present invention, reference will be made to the following Detailed Description, which is to be read in association with the accompanying drawings, wherein:

FIG. 1 is a block diagram of a GPU that may be used to implement mechanisms described herein;

FIGS. 2A-B illustrate one embodiment of a mechanism for performing a parallel tree-based scan;

FIG. 3 is a flow diagram illustrating a high level view of a process for performing a scan on a large input array, in accordance with an embodiment of mechanisms described herein;

FIG. 4 illustrates one embodiment of a scan process that may be performed in combination with other techniques described herein;

FIG. 5 is a flow diagram generally showing a process of performing a matrix scan of an input sequence block, in accordance with an embodiment of mechanisms described herein;

FIG. 6 is a logical flow diagram generally showing a portion of the initialization performed as part of the process of FIG. 5;

FIG. 7 is a block diagram illustrating an example of a two-dimensional padded matrix that may be used in conjunction with mechanisms described herein;

FIG. 8 is a flow diagram illustrating a high level view of a process for performing a segmented scan on a large input array, in accordance with an embodiment of mechanisms described herein; and

FIG. 9 is a flow diagram of a process for performing a segmented scan of an input sequence, in accordance with an embodiment of the mechanisms described herein.

### DETAILED DESCRIPTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention. Similarly, the phrase “in one implementation” as used herein does not necessarily refer to the same implementation, though it may, and techniques of various implementations may be combined.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “numeric multiple” of a value V refers to a value that is N×V, where N is a positive integer value.

The components may execute from various computer readable media having various data structures thereon. The components may communicate via local or remote processes such as in accordance with a signal having one or more data packets (e.g. data from one component interacting with another component in a local system, distributed system, or across a network such as the Internet with other systems via the signal). Computer components may be stored, for example, on computer readable media including, but not limited to, an application specific integrated circuit (ASIC), compact disk (CD), digital versatile disk (DVD), read only memory (ROM), floppy disk, hard disk, electrically erasable programmable read only memory (EEPROM), flash memory, or a memory stick in accordance with embodiments of the present invention.

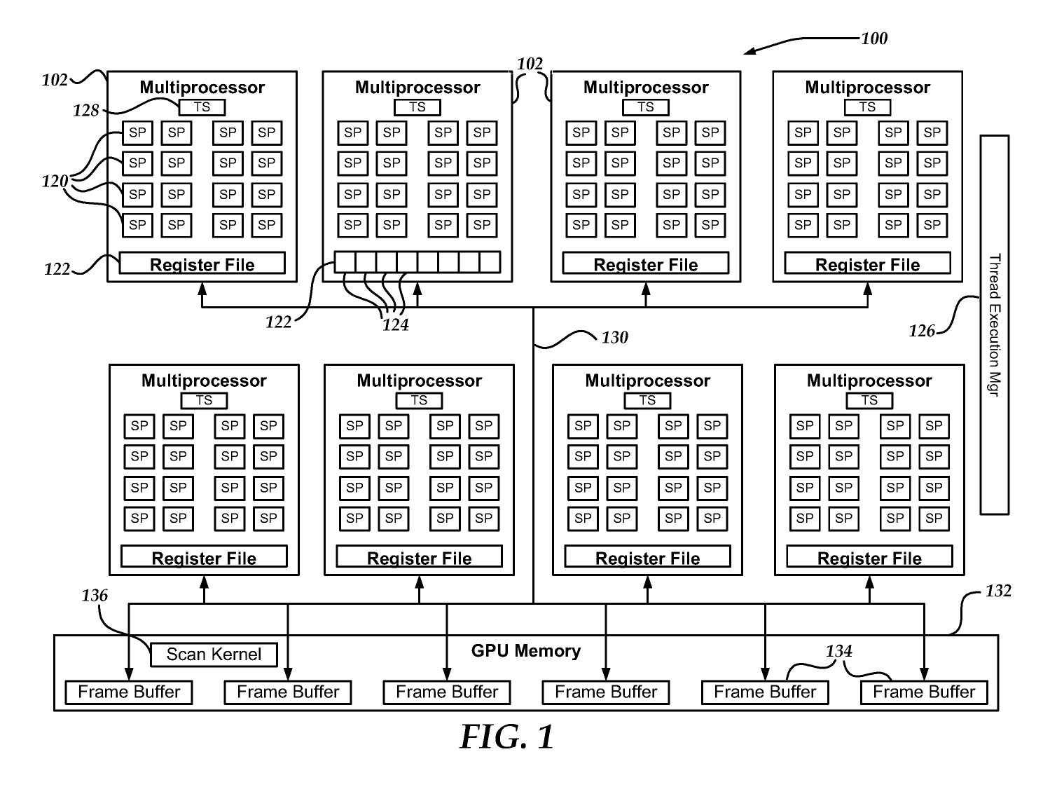

FIG. 1 is a block diagram of a parallel processing system 100 in which mechanisms described herein may be implemented. In particular, FIG. 1 illustrates an architecture of the NVIDIA G80 GPU, by NVIDIA Corp., of Santa Clara, Calif., though only a subset of components are shown. Aspects of the illustrated architecture may be included in other GPUs. Additionally, processing techniques described herein may be implemented on parallel processors that vary from that illustrated in FIG. 1. FIG. 1 is only an example of a suitable system and is not intended to suggest any limitation as to the scope of use or functionality of the present invention. Thus, a variety of system configurations may be employed without departing from the scope or spirit of the present invention.

Parallel processing system 100 may be employed as a component in a special purpose or general purpose computing device. Example computing devices include personal computers, portable computers, telephones, PDAs, servers, mainframes, electronic games, consumer electronics, or the like. In brief, one embodiment of a computing device that may be employed includes one or more central processing units, a video display adapter, and a mass memory, all in communication with each other via a bus.

As illustrated, parallel processing system 100 includes eight multiprocessing units 102, though a parallel processing system may include more or less than eight. Each of the multiprocessing units 102 includes multiple scalar processors (SPs) 120. Each of the SPs 120 may be configured to support numerous hardware threads. Thus, a multiprocessing unit 102 may provide tens, hundreds, or thousands of hardware threads. As used herein, the term “thread” refers to a hardware-supported thread of execution. A thread on a scalar processor may have a set of registers so that each thread has its own private registers.

A group of threads may operate in a single instruction multiple data (SIMD) fashion, in which each thread of the group executes the same instruction in parallel on the same or different data. For example, the group of threads may retrieve data in blocks, or perform the same operation on multiple data items concurrently. A group of threads that execute in a SIMD fashion is referred to as a “warp.” In some embodiments, threads of a warp may be subdivided into groups, such that threads of the warp are scheduled concurrently, but the execution of the groups is interleaved. For example, in one embodiment, a warp is divided into two half-warps, and though all threads of the warp are scheduled to execute an instruction concurrently, threads of the first half-warp execute simultaneously, followed by execution of threads of the second half-warp, so that the half-warps are interleaved in their execution.

In the illustrated embodiment, each multiprocessing unit 102 includes a shared register file 122 accessible by the threads that execute in the multiprocessing unit. A shared register file is sometimes referred to as a fast shared memory, though the former term is used herein to distinguish it from GPU global memory. In one configuration, the shared register file 122 has a significantly lower latency and a higher bandwidth than the GPU memory 132. The difference can be in orders of magnitude. In one embodiment, accesses to the shared register file may be approximately as fast as register accesses, if there are no bank conflicts. It is therefore advantageous to use the shared register file 122 rather than the GPU memory 132 for most operations. The shared register file 122 may be interleaved and subdivided into multiple memory banks 124. In the interleaved architecture, consecutive units of memory are interleaved so that for a contiguous sequence of memory bank units, a first memory bank unit may map to bank 0, the next memory bank unit may map to bank 1, and so forth. The numBanks unit may map to bank 0, where numBanks represents the number of memory banks. In one embodiment, a memory bank unit is equal to a machine word size, though this may differ in various architectures. The memory banks 124 of a shared register file within a multiprocessing unit 102 may be configured so that multiple memory banks may be accessed in parallel by corresponding threads of the multiprocessing unit. Synchronization primitives may enable communication between threads running on the same multiprocessing unit. Though not illustrated, multiprocessing unit 102 may also include private register files that are used by the threads. In a private register file, the data is private to a particular thread.

When two or more threads attempt to concurrently access the same memory bank, a bank conflict may occur, resulting in the accesses being serialized. In some embodiments, a bank conflict may occur if multiple threads of the same warp attempt to concurrently access the same memory bank of a shared register file. In some embodiments, bank conflicts are limited to subgroups of a warp, referred to herein as conflict groups. A memory bank conflict may occur if two threads of the same conflict group attempt to access the same memory bank, but does not occur if two threads of different conflict groups attempt to access the same memory bank. In one embodiment, a conflict group is the entire warp. In one embodiment, a conflict group is a half-warp, such that there are two conflict groups in a warp. In some embodiments, a warp may contain more than two conflict groups. Memory bank conflicts increase latency, resulting in a degradation of performance. Mechanisms described herein configure threads of a conflict group to concurrently access data of different memory banks, rather than in a common memory bank.

As illustrated in FIG. 1, a parallel processing system may include a thread execution manager 126 that manages the configuration and execution of threads in each of the multiprocessing units 102. Each of the multiprocessing units 102 may include a local thread scheduler 128 that schedules the threads within the corresponding multiprocessing unit. In one embodiment, the local thread scheduler 128 may schedule each of the threads in a warp to execute an identical instruction in parallel. If execution of the instruction includes an access to a shared register file, the accesses also are performed in parallel, if there are no memory bank conflicts. This provides a built-in synchronization among the threads. As discussed above, in one embodiment, the actual execution of subgroups of threads within a warp may be interleaved.

Each of the threads in each multiprocessor may access a GPU memory 132 over an interconnect 130. The GPU memory 132, sometimes referred to as “global memory,” may include one or more frame buffers 134. The GPU memory may also include one or more program modules, each including program instructions that are loaded into each multiprocessor and executed by threads of the multiprocessors. In one configuration, the GPU memory 132 includes a scan kernel 136 that includes a program module for performing the scan processes described herein, or a portion thereof.

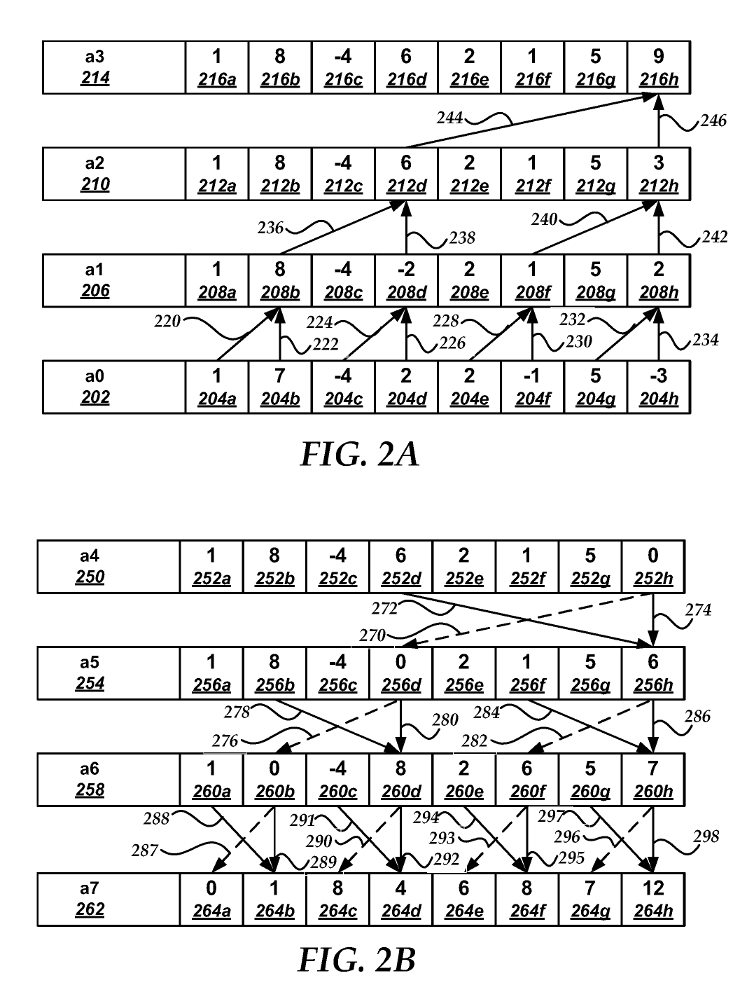

FIGS. 2A-B illustrate one embodiment of a mechanism for performing a parallel tree-based scan. FIG. 2A illustrates an example input array a₀ 202 having eight elements, each element being one memory bank unit in size. Though the input array a₀ 202 is limited to eight elements for illustrative purposes, mechanisms described may be used with much larger input arrays. The illustrated elements may be considered as a portion of a much larger sequence of elements. The parallel tree-based scan herein described may be performed in two phases. FIG. 2A illustrates a reduction phase; FIG. 2B illustrates a down-sweep phase. FIG. 2A includes array a₁ 206, array a₂ 210, and array a₃ 214. In one implementation, each of these arrays represents a state of the same array as input array a₀ 202 at a different time, and all may be implemented in the same physical memory arrangement. Thus, elements that are not changed simply remain with the same value in each subsequent state. Thus, elements 204b, 208b, 212b, and 216b may represent the same array element stored in the same memory location, though the value stored within may change.

In the example scan of FIGS. 2A-B, addition is the operator used. Arrows 220-246 represent connectors of a binary tree, with selected elements of the arrays representing nodes, such that element 216h is the root of the tree. In the discussion that follows, the value stored within an element is referred to simply as the element, and the distinction between the value and the element may be inferred by the context. During a first iteration, elements 204a and 204b are added, with the result placed in element 208b, as indicated by arrows 220 and 222. During the same iteration, elements 204c and 204d are added, with the result placed in element 208d, as indicated by arrows 224 and 226; elements 204e and 204f are added, with the result placed in element 208f, as indicated by arrows 228 and 230; and elements 204g and 204h are added, with the result placed in element 208dh as indicated by arrows 232 and 234.

During the above described iteration, each of the four addition operations may be performed in parallel by a corresponding thread. Each of the threads may, in parallel, retrieve a first operand, then retrieve a second operand, and then perform the addition, storing the result as described. As illustrated, elements 204a, 204c, 204e, and 204g are the respective first operands; elements 204b, 204d, 204f, and 204h are the second operands. The distance between the elements during each access is two. Thus, the iteration is said to have a stride of two. In a configuration in which each of the first operands is in a different respective bank of the shared register file, the memory accesses may be performed in parallel with minimal latency, though the threads may all belong to the same conflict group.

In the next iteration, the results of the first iteration are used as operands to addition operations that are performed in parallel. Thus, elements 208b and 208d are added, with the result placed in element 212d, as indicated by arrows 236 and 238; elements 208f and 208h are added, with the result placed in element 212h, as indicated by arrows 240 and 242. In this iteration, two threads may perform the operations in parallel, and the data accesses have stride of four.

In the next iteration, elements 212d and 212h are added, with the result placed in element 216h, as indicated by arrows 244 and 246. One thread may perform this operation, with a stride of eight. With configurations having an input array larger than eight, the iterations may continue until a single value results. The resultant value, stored in element 216h as illustrated, is the reduction of the original input array a₀ 202.

FIG. 2B illustrates a second phase of the parallel tree-based scan, a down-sweep phase. While the first phase may be viewed as a bottom up traversal of a binary tree, the down-sweep phase may be viewed as a top down traversal of the binary tree. The second phase begins with the array a₃ 214 produced by the reduction phase. In one implementation, the down-sweep phase begins by setting an operator identity element at the root of the tree, which is the location of the reduction value from the reduction phase. In array a₄ 250, the element 252h (an updated version of element 216h) is the root of the tree, and is set to the additive identity zero. Other elements of array a₄ 250 remain unchanged from array a₃ 214.

The process then performs a mini-scan of the elements at the next level of the tree. A mini-scan refers to a scan that is performed on two elements. In the illustrated example, the elements at the next level are elements 256d and 256h, which are the left and right child nodes of the root element 252h. In performing a mini-scan, the value of the left child is saved temporarily, so that it may be used after it is given a replacement value. Thus, the starting value of element 256d, which is the value 6 from element 252d, is saved. At each mini-scan involving a root node and two child nodes, the left child is given the value of the root node, and the right child is given the sum of the left child (as saved prior to the replacement) and the root element. In FIG. 2B, the insertion of the parent node into the left child is shown by a dashed arrow, and the addition is shown by two solid arrows.

The result of the mini-scan on these elements is that the identity value of element 252h is placed in the first element (256d), as shown by dashed arrow 270, and the sum of the two elements is placed in the second element (256h), as shown by solid arrows 272 and 274. The result of this mini-scan is the array a₅ 254, having a value of zero at element 256d, a value of 6 at element 256h, and the remaining elements unchanged. Though the example of FIG. 2 shows a single addition operation with two operands from array 250, in a configuration having a longer sequence, there may be multiple operations employing multiple threads and concurrent memory accesses at this level. The concurrent memory accesses would have a stride of eight. As for the reduction phase, the arrays 250, 254, 258, and 262 represent a state of the same array as input array a₀ 202 at a different time, and all may be implemented in the same physical memory arrangement.

The threads are then synchronized. The down-sweep phase may perform a next iteration with two threads. A first thread may perform a mini-scan of the elements 256b and 256d. Once again, as indicated by dashed arrow 276, the element 256d is inserted into element 260b of array a₆ 258, and elements 256b and 256d are added, as shown by arrows 278 and 280, with the sum inserted in element 260d. A second thread operates on elements 256f and 256h. As shown by dashed arrow 282, element 256h is inserted into element 260f, as shown by arrows 284 and 286, elements 256f and 256h are added, with the sum placed in element 260h. This iteration has a stride of four. Thus, at each successive iteration, the number of threads doubles, and the stride is decreased by a factor of two. Threads may be synchronized once again.

At a next iteration, four threads operate at a stride of two. Thus, the four threads operate to respectively insert element 260b into element 264a (dashed arrow 287), element 260d into element 264c (dashed arrow 290), element 260f into element 264e (dashed arrow 293), element 260h into element 264g (dashed arrow 296). The four threads then perform addition operations: the sum of elements 260a and 260b is inserted into element 264b (arrows 288 and 289); the sum of elements 260c and 260d is inserted into element 264d (arrows 291 and 292); the sum of elements 260e and 260f is inserted into element 264f (arrows 294 and 295); and the sum of elements 260g and 260h is inserted into element 264h (arrows 297 and 298).

The array a₇ 262 thus has the results of performing a parallel tree-based exclusive scan on the original input array a₀ 202. The process may be modified to perform an inclusive scan. This process generally proceeds in log n stages, where n is the number of elements in the input array.

As described above, at each level, one or more mini-scans are performed. In one embodiment, at each level all of the mini-scans are performed with one thread. In one embodiment, at each level the mini-scans may be performed with multiple threads executing and accessing the shared register file in parallel. For example, each mini-scan at a level may be performed by a corresponding thread in parallel with the other mini-scans of the same level.

In configurations employing a shared interleaved memory, such as described in FIG. 1 and associated discussion, a parallel tree-based scan may result in memory bank conflicts. For example, in the configuration illustrated in FIG. 2, if the array a₀ 202 is stored in an interleaved shared memory having four memory banks, at each level of the tree, the concurrent memory accesses will cause memory bank conflicts. One technique that reduces bank conflicts inserts padding cells at intervals in the array. Padding cells inserted into an array change the “pitch” of memory accesses. While stride refers to the distance between data elements, excluding padding cells, that are being accessed concurrently, pitch refers to the physical distance between the elements including padding cells. For example, in a configuration in which a padding cell is inserted after every four cells of an array, an access having a stride of four has a pitch of five. In the same configuration, an access having a stride of two has a pitch of either two or three, depending on the location relative to padding cells. A padding cell inserted after every four cells may avoid bank conflicts when the stride is two or four. However, with a stride of eight, the pitch becomes ten, and the bank conflicts remain. If a padding cell is inserted after every eight cells, bank conflicts may be avoided with a stride of eight, but they would occur at a stride of two. Mechanisms described herein address problems of bank conflicts with an interleaved shared memory. It is to be noted that a parallel tree-based process may be combined with other processes described herein.

In the above discussion, it is assumed that a data element has an element size of one memory bank unit. In a configuration in which a padding cell is inserted after every four data cells, and each data cell is two memory bank units, a concurrent access of every four data cells has a stride of 4×2=8, and a pitch of 4×2+1=9. Similarly an access of every other data cell has a stride of 4 and a pitch of 4 or 5.

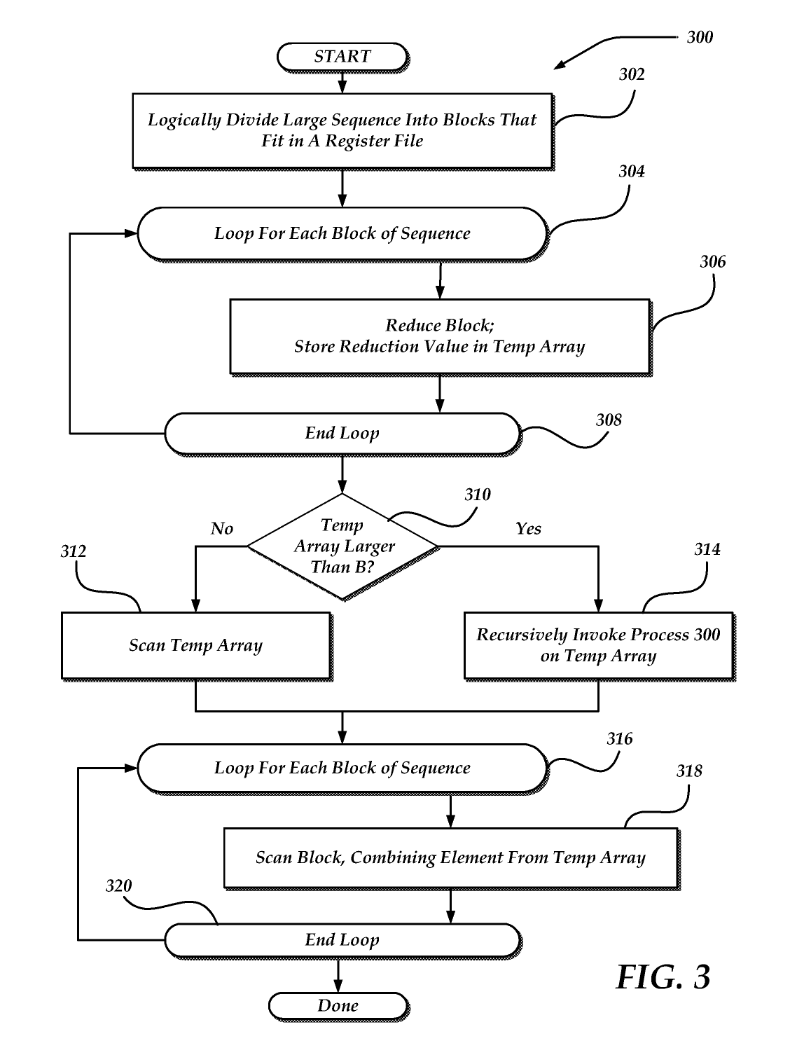

A scan may be efficiently performed on a large input sequence of size N by subdividing the input sequence into blocks of size B that fit in a shared register file. FIG. 3 is a flow diagram illustrating a high level view of a process 300 for performing a scan on a large input sequence. The techniques of process 300 are referred to as a reduce-Scan-scan (rSs), in that it includes a reduction, an intermediate scan, and a final scan. Process 300 may be employed in a processing system including a parallel processor such as the parallel processing system 100 of FIG. 1 or variations thereof. As shown in FIG. 3, after a start block, at block 302, a large input sequence is logically divided into blocks that fit within the shared register file. At a block 304, a loop begins, including an iteration for each block of the input sequence. The block of each iteration is referred to as the current block. At block 306, the current block may be copied into the shared register file and reduced, such that each reduction is performed while processing the entire block within the shared register file. The reduction of each block may employ multiple threads, as described herein. In one embodiment, process 500, discussed below, or a portion thereof, is used to perform the scan of each block. The reduction value of each block may be inserted into a corresponding element of a temporary array. The process may flow to block 308, which terminates the loop beginning at block 304.

The temporary array Tₒ that holds the reduction values of each block has a maximum size of N/B. The process may flow to block 310, where a determination is made of whether the temporary array Tₒ is larger than B. If not, the process may flow to block 312, where a scan of the temporary array Tₒ may be performed, storing the results in a second temporary array T₁. The second temporary array Tₒ may be the same as the first temporary array Tₒ, but is shown and discussed as a separate array for illustrative purposes.

If, at block 310, it is determined that the temporary array Tₒ is larger than B, the process may flow to block 314, where Tₒ is scanned by recursively invoking process 300, with Tₒ as the input sequence. The recursion may proceed one or more levels deep, until the temporary array at a level is not greater in size than B, so that it is scanned at bock 312 rather than follow another level of recursion.

After either block 312 or block 314, the process may flow to block 316, where a loop begins that iterates over each block of the input sequence. At block 318, the current block being iterated over may be scanned. During the scan of a block, an element of the temporary array Tₒ corresponding to the block may be combined with the block. This element represents the reduction value of all elements preceding the block in the input sequence. Thus, reduction values of each block may be propagated to the succeeding block. The actions of block 318 may include copying the current block into the shared register file prior to processing, and copying the modified block back to the global memory.

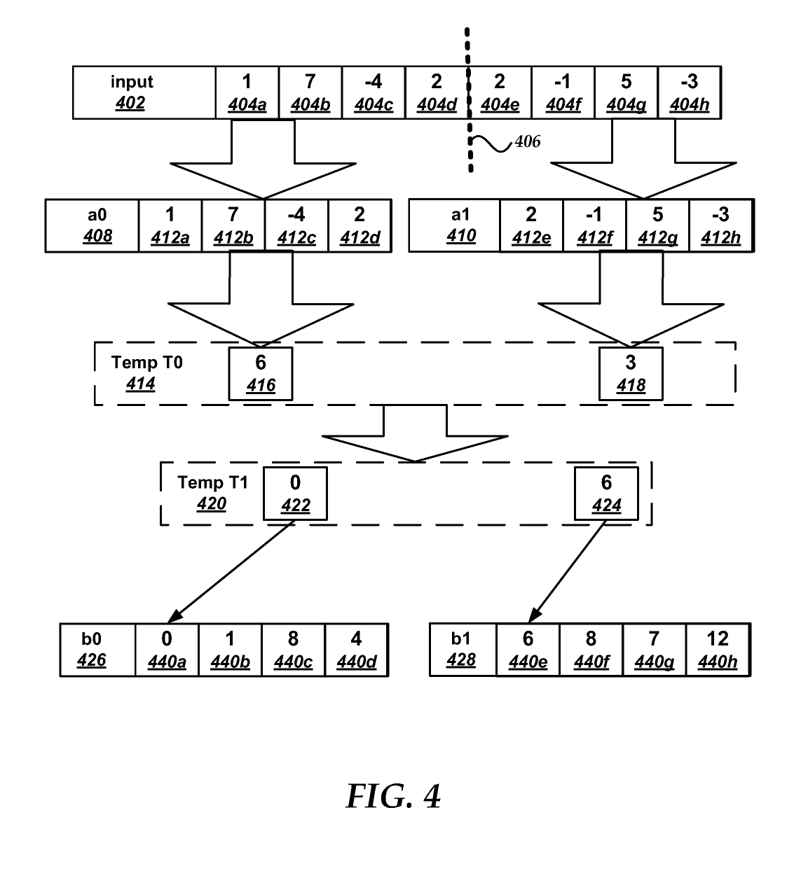

This process is illustrated in FIG. 4, which shows a recursive multi-block scan that may be performed in combination with other techniques described herein. FIG. 4 illustrates an input sequence 402, having elements 404a-h. In the illustration of FIG. 4, addition is used as the operator, though other operators may also be employed. FIG. 4 illustrates states of a process in which a block size of four is used to subdivide an input sequence having eight elements, though the mechanisms may be applied to much larger block sizes and sequences.

As shown by dashed line 406, input sequence 402 is logically divided into blocks of size B, such that each block may fit in a low-latency shared register file. The resultant blocks in the example are block a₀ 408, having elements 412a-d, and block a₁ 410, having elements 412e-h. A reduction is then performed on each block. The results of each reduction are stored in temporary memory storage, such as temporary array T₀ 414, which may also be in the shared register file. As illustrated, the reduction value of block a₀ 408 is 6, which is stored in temporary element 416; the reduction value of block a₁ 410 is 3, which is stored in temporary element 418.

A scan may then be performed on temporary array T₀ 414. Temporary array T₁ 420 represents the results of the scan, though temporary array T₁ 420 may be the same array in the same physical location as temporary array T₀414. The result of this scan is to place the additive identity zero in the first array element 422, and each subsequent element is set to the sum of all previous elements in the input temporary array 414. As illustrated, element 424 therefore receives the value of 6.

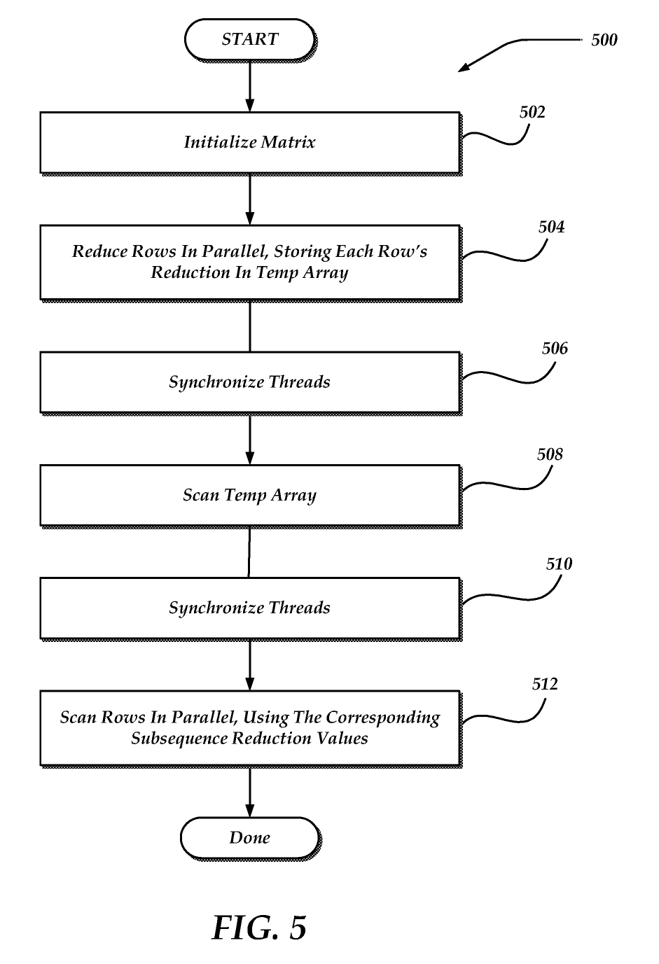

A scan operation may then be performed on block a₀, combining the corresponding element 422 as the first element of block a₀. This scan produces block b₀ 426, having elements 440a-d. In one implementation, block b₀ 426 represents a state of block a₀ 408 and is in the same physical location in the shared register file. A scan operation may then be performed on block a₁ 410, combining the corresponding element 424 as the first element of block a₁ 410. This scan produces block b₁ 428, having elements 440e-h. In one implementation, block b₁ 428 represents a state of block a₁ 410 and is in the same physical location in the shared register file. The combined sequence of blocks b₀ 426 and b₁ 428 is the output sequence resulting from the scan of the original input sequence 402. This may be extended to additional blocks, based on the input sequence size. In the process illustrated in FIG. 4 and described herein, each of the reduction and scan operations may be performed within the shared register file, thereby reducing memory access times. In one implementation, the reduction or scan operations may be performed using a two-dimensional matrix and associated techniques, as illustrated in FIGS. 5-9 and associated discussion herein.

When determining a block size B to be used in the mechanisms described herein, there may be aspects of the system architecture that influence the determination. For example, in some processor architectures, having a value of B that is a power of two provides advantages such as coalescing memory accesses or enabling more efficient shift operations when performing address arithmetic. A value of B that is a numeric multiple of the machine word size may also enable some optimizations, such as packing flags corresponding to row elements into machine words, as described herein. In one implementation, B may be determined to be a power of two, though other implementations may not make this restriction.

FIG. 5 is a flow diagram illustrating a process 500 for performing a scan of an input sequence block. Process 500, or a portion thereof, may be performed as part of the actions of blocks 312 or 318 of process 300 in FIG. 3. The process 500 employs a matrix structure to enhance the efficiency of the process when executed in conjunction with a parallel processor. The GPU of FIG. 1, and variations thereof, are examples of such a parallel processor. Process 500 may be executed on a GPU or another parallel processing system. In one configuration, process 500 may be executed by program instructions of scan kernel 136 of FIG. 1. After a start block, at block 502, initialization is performed. This initialization may include determining the dimensions of a matrix to be used, as well as padding intervals to be inserted in the matrix. Because aspects of the initialization assist in understanding process 500, further details of the initialization are now discussed prior to proceeding with FIG. 5.

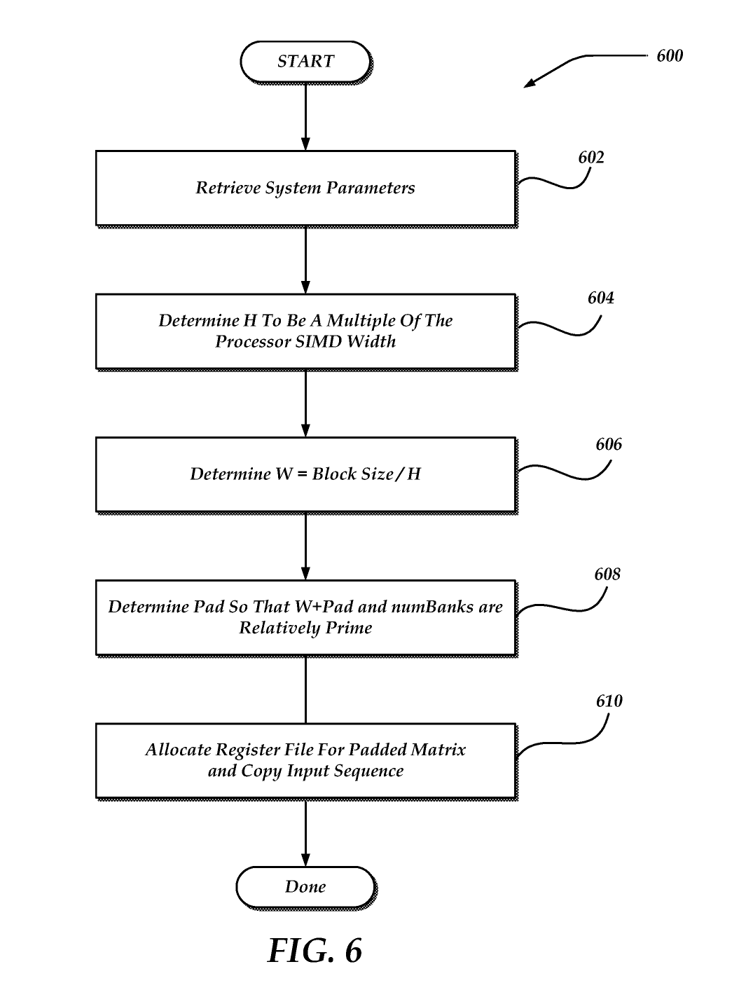

FIG. 6 illustrates a process 600 for initializing a matrix, which may be performed at block 502 of FIG. 5, in one embodiment. As shown in FIG. 6, after a start block, at block 602, data and system parameters are retrieved. The system data may include the block size to be used for the scan. As discussed herein, the block size is determined to be such that a block may fit in the corresponding shared register file. The system data may also include the number of banks in the shared register file, the conflict group size, and the multiprocessor warp size.

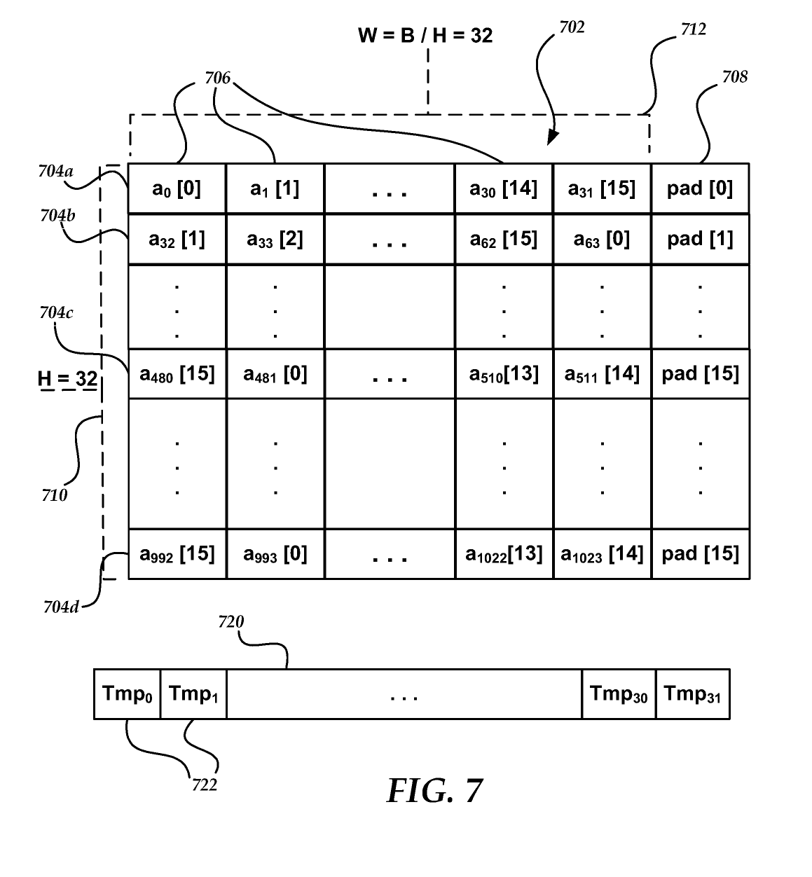

In one implementation, two matrices are determined. A data matrix, having logical dimensions H×W, contains elements of the input sequence to be scanned. A padded matrix, having physical dimensions H and (W×sizeOfElement)+P, is a superset of the data matrix formed by adding one or more columns to the data matrix. The term “sizeOfElement” is used herein to represent the number of banks occupied by an input sequence data element in the shared register file. It is therefore the physical size of an input sequence data element in memory bank units. Note that when sizeOfElement is not equal to one, the padding cells may have a different physical size than the data cells. The columns may be filled with padding, or otherwise used. In one embodiment, the columns may be used to store the temporary array 720 of FIG. 7, described below. In one configuration, for example, an sizeOfElement may be equal to one machine word. In another example, input sequence data elements may be represented as double-words, and sizeOfElement may be equal to two machine words.

Processing may flow to block 604, where the height (H) of the matrix is determined. In one implementation, H is determined to be the processor warp size, or a multiple thereof. In a configuration in which a warp contains more than one conflict group, selecting a value of H to be equal to, or a numeric multiple of, the warp size enables efficient use of threads. A value of H that is not exactly equal, but approximately equal to a numeric multiple of the warp size may be used, though a loss in efficiency may occur.

Processing may flow to block 606, where the logical width (W) of the data matrix is determined. In one implementation, W may be determined based on the height H and the block size. More specifically, it may be determined such that W=B/H. Note that for a large block size, W may be considerably larger than the number of memory banks and considerably larger than a warp.

Processing may flow to block 608, where padding is determined. In one implementation, zero or more pad blocks may be inserted at the end of each row, or after each W values. In one implementation, the number of pad blocks (P) may be determined such that the value (W×sizeOfElement)+P and the number of memory banks are relative primes. This relationship is used to avoid or minimize bank conflicts that may occur during the scan process, as described further herein. In one implementation, the number P is determined to be the minimum non-negative integer value such that the value (W×sizeOfElement)+P and the number of memory banks are relative primes. In one implementation, in which the value W×sizeOfElement is relatively prime to the number of memory banks, the value P may be selected to be zero. The number of pad blocks becomes the number of pad columns that are added to the data matrix to form the padded matrix. Upon determining the number of pad blocks (P) to be added to each row, the dimensions H and (W×sizeOfElement)+P of the padded matrix are known.

The process may flow to block 610, where the matrices may be generated and filled with data and padding. A block of the shared register file may be allocated to accommodate the padded matrix. As discussed above, the data matrix is a subset of the padded matrix, having the same number of rows, but a subset of the columns of the padded matrix. The data matrix may be formed by copying elements from the input sequence, filling in rows with the data, until the data matrix is filled. In one implementation, the padding columns are not used. In one implementation, the padding columns may be used as memory for other purposes, such as the temporary array discussed herein.

Following block 610, the process may flow to a done block, and return to a calling program, such as process 500 of FIG. 5. It should be noted that any one or more, or even all, of the initialization actions described herein are not required as part of the process 500 or process 900, described below. In one embodiment, some, or all, of the actions may be performed at a time prior to the start of process 500 or process 900. In some embodiments, dimensions or other values used by process 500 or process 900 may be predetermined and configured in the system, either separate to, or integrated with, program instructions that implement process 500 or process 900, or they may be provided in another manner. In one implementation, parameters such as the matrix height H, the block size B, the matrix width W, or padding P may be determined by empirical evaluation for a system configuration, for use in subsequent processes described herein.

FIG. 7 illustrates a two-dimensional padded matrix 702 that may result from performing the process 600, in an example configuration. In the example of FIG. 7, a block size of 1024 and a warp size of 32 are used. It is also assumed that the number of banks is 16, and a conflict group size is 16, or a half-warp. Thus, the matrix height (H) 710 is determined to be the warp size 32; the data matrix width (W) 712 is determined to be 1024/32=32. It is to be noted that a matrix height (H) of 32 in this example enables 32 threads to concurrently access different memory locations without a memory bank conflict, due to a conflict group being equal to a half-warp. Further, by selecting a matrix height that is the warp size, the data matrix width (W) is maximized, resulting in minimal padding cells.

It is to be noted that, in some implementations, the number of banks is derived from the hardware configuration of the parallel processor, and specifically the shared register file. However, in some implementations, a process may be configured to employ a subset of the hardware memory banks with the mechanisms described herein. Thus, as used herein, the number of memory banks may be a value other than the hardware configuration.

In one implementation, a number of padding columns, also referred to as the padding number, is determined such that (W×sizeOfElement)+P is relatively prime to the number of banks. In the example of FIG. 7 and the associated discussion herein, it is assumed that sizeOfElement=1, so that each data element is contained in a single memory bank, the physical padded matrix width is W+P, and P is determined so that W+P is relatively prime to the number of memory banks. In the example padded matrix 702, padding is determined to be one, in that 32+1 and 16 are relatively prime. Padded matrix 702 therefore contains 32 rows 704 and 32 data columns 706 plus a pad column 708. Thus, every 33^{rd} cell in the padded matrix 702 is a pad.

As illustrated in FIG. 7, each element of the data matrix is referred to by the letter “a” with a subscript number, the subscript number indicating the element's position in the input sequence relative to the block. The rows of the matrix may be referred to by row numbers, such that the row R₀ having first data element a₀ is the first row. A preceding row Rᵢ relative to a row Rⱼ is any row that has a lower row subscript, such that i<j. A preceding row Rᵢ of Rⱼ includes a subsequence of data elements having lower data element subscripts, such that the data elements of Rᵢ precede the data elements of Rⱼ in the input sequence. An immediately preceding row Rᵢ of Rⱼ is a row that immediately precedes Rⱼ, such that j=i+1. In the padded data matrix 702, rows Rₒ 704a and R₁ 704b precede R₁₅ 704c, and row Rₒ 704a immediately precedes R₁ 704b.

Each cell of the data matrix shows the input sequence element, such that the subscript number is the input sequence number. Each cell of the padded matrix 702 also shows, in brackets, the bank number in which the element is stored. Note that by adding a pad at the end of each row, the bank of each element is offset by one in each immediately succeeding row, so that each column, for each of the ½ H rows, contains elements that are distributed across memory banks. When the ½H threads accesses the element of each column, there are no memory bank conflicts, due to the configuration of a conflict group equal to ½H.

It is to be noted that the padded matrix 702 may be used in conjunction with the GPU of FIG. 1, which has 16 memory banks. In particular, padded matrix 702 includes 32 contiguous data elements in each row, followed by a padding cell. In particular, padded matrix 702 includes twice as many contiguous data elements as there are memory banks in the corresponding GPU. Thus, the relationship of padding columns to data cells and memory banks may be such that the number of contiguous data elements between padding cells may be greater than the number of memory banks, and may in some configurations be many times greater than the number of memory banks. The number of contiguous data elements may also be a value that is not an exact numeric multiple of the number of memory banks.

The rows may be grouped into conflict groups. Thus, in the example of FIG. 7, the conflict group size is 16, and the matrix height is equal to two conflict groups. This allows 32 rows to be traversed in parallel without memory bank conflicts. Further, as discussed above, in some embodiments, subgroups of a warp may have instructions executed in an interleaved manner. Thus, though only half of a warp may execute an instruction simultaneously, because a conflict group is equal to a half-warp, the processes discussed herein apply whether the half-warp executions are interleaved or not. As discussed herein, the 32 rows are considered to be traversed in parallel, regardless of whether execution of thread subgroups is interleaved.

Returning now to FIG. 5, following initialization, the process may flow to block 504, where a reduction is performed on each row. As stated above, this may be performed in parallel on all rows, each thread performing the reduction for a corresponding row. In one embodiment, each thread may sequentially reduce the corresponding row. The result of each row's reduction may be inserted into a corresponding element 722 of a temporary array, such as temporary array 720 of FIG. 7. It is to be noted that, since each thread is performing computations on its own corresponding data, during the reduction of a row group, synchronization of the threads is not needed. This may reduce the amount of synchronization that is used as compared with other mechanisms.

It is to be further noted that, during a reduction, within a row group, the shared register file is accessed with a constant stride equal to the data matrix width W×sizeOfElement, which is 32 in the example of FIG. 7, and a constant pitch equal to (W×sizeOfElement)+P. By having a constant pitch equal to the physical data matrix width W×sizeOfElement plus the padding P, such that (W×sizeOfElement)+P is relatively prime to the number of banks, bank conflicts may be avoided, resulting in low-latency memory accesses. As noted herein, in some implementations, the value B may be selected to be a power of two. Also, in some systems, such as the GPU illustrated in FIG. 1, the warp size is a power of two. In an implementation having a value of H as a numeric multiple of the warp size, the logical data matrix width W may thus be a power of two. In such configurations, a padding P equal to one is sufficient to have (W×sizeOfElement)+P be relatively prime to H.

After performing the parallel reductions at block 504, the process may flow to block 506, where thread synchronization may be performed. In one implementation, thread synchronization includes synchronizing the threads corresponding to the rows of the padded matrix 702. This may be, for example, the threads of the warp. The process may then flow to block 508, where a scan is performed on the temporary array 720. In one implementation, the results of the scan replace the values of the temporary array prior to the scan. In one implementation, the scan of the temporary array may be performed by a single thread sequentially. In one implementation, the scan of the temporary array may use multiple threads to improve performance. In one implementation, the scan of the temporary array may use matrix scan techniques described herein. That is, the temporary array may be logically formed into a two-dimensional matrix, and the mechanism of process 500 used to perform a scan on the temporary array matrix. In one implementation, the scan of the temporary array may employ a parallel tree-based scan, such as illustrated in FIGS. 2A-B. The selection of which technique to use when performing a scan of the temporary array may be based on the size of the temporary array. Upon completing the scan, the temporary array 720 contains, for each row, a corresponding element value that represents the reduction of the elements preceding the row.

After performing the scan of the temporary array 720, the process may flow to block 510, where thread synchronization may be performed, as in block 504. The process may flow to block 512, where a scan operation may be performed on each row of the data matrix, combining the corresponding element 722 of the temporary array 720 as the first element of the row. That is, for each row, the reduction of the immediately preceding row is inserted as the first element of the row in conjunction with the scan of the row. As for the reductions of block 504, the scans of each row may be performed in parallel. In one embodiment, each thread may sequentially scan the corresponding row. As for the reductions of block 504, this process does not require synchronization to be performed during the parallel scans. This may further reduce the number of synchronizations that are used. In one implementation, the results of each row's scan may replace the original values in the row.

Thus, in the example matrix of FIG. 7, 32 rows may be reduced in parallel during the first traversal, and the 32 rows may be scanned in parallel during the second traversal. Since the example describes 16 threads in each conflict group, and each of the 16 threads accesses a different memory bank in parallel, there are no memory bank conflicts.

The process may then flow to a done block, and return to a calling program.

In one embodiment, in a configuration having a number of remaining input sequence values less than the data matrix size, any extra cells may be padded with the identity element, such as the value zero for addition. This may simplify the logic, reduce the number of program instructions, or reduce register usage.

Following is a pseudocode listing, showing an implementation of process 500.

```
Matrix Scan ( ) {
  // Reduce rows using H threads
  if (threadID < H) {
    T* row = & s[threadID* ((W × sizeOfElement)+pad)];
    T res = row[0];
    for (int i=1; i< W; ++i) res = res ⊕ row[i];
    tempArray[threadID] = res; // reduction value
  }
sync ( );
scanTempArray ( );
sync ( );
// Scan rows using H threads
If (threadID < H) {
    T* row = &s[threadID * ((W × sizeOfElement)+pad)];
    T res = tempArray[threadID];
    for (int i = 0; i < W; ++i) {
      T t = row[i];
      row[i] = res;
      res = res ⊕ t;
    }
  }
}
```

The mechanisms described herein may vary in a number of ways. As discussed herein, the operator used in a scan may be any left associative binary operator, including multiplication, logical or, exclusive or, minimum, or maximum operations. The elements of the input sequence may be integer values, unsigned integers, floating point, double, or other types. The scans may be forward or backward scans, and inclusive or exclusive scans. In one implementation, to perform a backward scan, a block is reversed when it is loaded into the shared register file. A forward scan technique is then applied to the block. The results are then reversed when they are stored into global memory. In one implementation, the blocks remain in their original order, and the sequence is traversed in reverse order. In one such implementation, the order of the operands in each operation may be reversed, to allow support for an operator that is not commutative.

The mechanisms described herein are advantageous in configurations in which the block size is greater than or equal to the number of banks multiplied by the processor warp size. However, these mechanisms may also be used with smaller blocks.

The mechanisms described above may be employed to perform segmented scans. A segmented scan may represent multiple input sequences that are concatenated into a single input vector. A second vector, referred to herein as a “flag” vector, may identify the original segments. In one implementation, the flag vector is a vector of head-flags, where a set flag denotes the first element of a new segment at a corresponding location in the input sequence, and a zero flag indicates a continuation of a segment. In one implementation, flags of a flag vector may be packed into an integer value, or word. For example, 32 consecutive flags may be packed into a single four-byte word, though other word sizes may be used in various architectures.

In one implementation, when traversing elements of an input sequence in the processes described herein, the flag vector is checked to determine when a new segment begins. When a new segment begins, the running scan or reduction value is not propagated to the next segment.

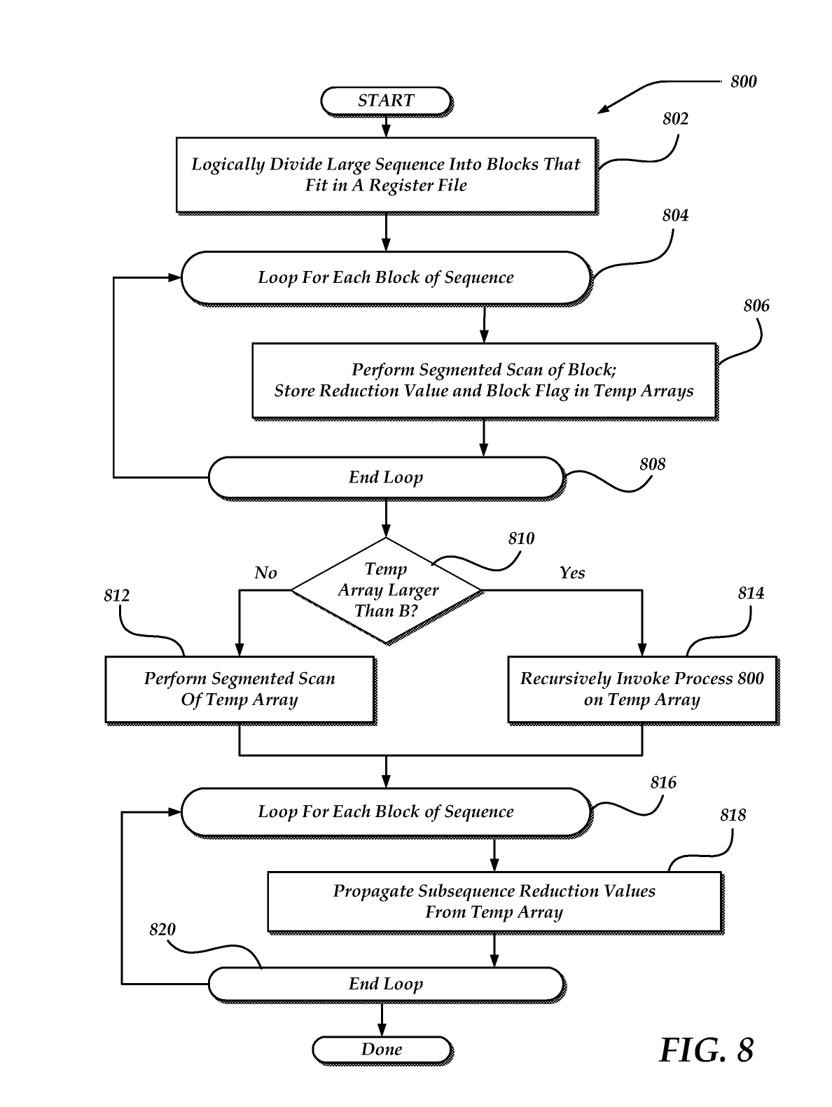

FIG. 8 is a flow diagram illustrating a high level view of a process 800 for performing a scan on a large input sequence. Process 800 may be used to perform a segmented scan, where the input sequence is divided into zero or more segments. The techniques of process 800 are referred to as a scan-Scan-propagate (sSp), in that it includes a first scan, an intermediate scan, and a propagation of reduction values. Process 800 may be employed in a processing system including a parallel processor such as the parallel processing system 100 of FIG. 1 or variations thereof.

As shown in FIG. 8, after a start block, at block 802, a large input sequence is logically divided into blocks that fit within the shared register file. At a block 804, a loop begins, including an iteration for each block of the input sequence. The block of each iteration is referred to as the current block. At block 806, the current block may be copied into the shared register file and processed, so that the processing is performed while the entire block is maintained within the shared register file. The elements of a flag vector corresponding to the block may also be copied to the shared register file. Specifically, at block 806, a segmented scan may be performed on the block. The segmented scan of each block may employ multiple threads, as described herein. In one embodiment, process 900, discussed below, or a portion thereof, is used to perform the segmented scan of each block.

As discussed above, a vector of flags may be used to determine the boundary of a segment in the block. When a new segment begins, the reduction value may be reset to the operator identity, so that values from a prior segment are not propagated to a new segment. Thus, the reduction value corresponding to a block is the reduction value of the last segment of the block, or more specifically, the portion of the last segment that falls within, or precedes, the current block. The reduction value of each block may be inserted into a corresponding element of a temporary array. In one embodiment, an array of block flags contains a block flag corresponding to each block. The block flag indicates whether there is a segment boundary in the corresponding block of the input sequence. It is set if there is a segmentation flag corresponding to any element of the block, and not set if such a segmentation flag does not exist. For each block, the corresponding block flag is stored in the block flags array. The process may flow to block 808, which terminates the loop beginning at block 804.

The temporary array Tₒ that holds the reduction values of each block has a maximum logical size of N/B and a maximum physical size of (N/B)×sizeOfElement. The process may flow to block 810, where a determination is made of whether the temporary array Tₒ is larger than B. If not, the process may flow to block 812, where a segmented scan of the temporary array Tₒ may be performed, storing the results in a second temporary array T₁, which may be the same as the first temporary array. In one embodiment, the segmented scan of the temporary array Tₒ may use the block flags array described above to determine whether a new segment begins in each block. If a new segment begins, the scan may be reset to the identity value of the scan operation, thus preventing propagation of values across segments. In one embodiment, process 900, discussed below, or a portion thereof, is used to perform the segmented scan of each block.

If, at block 810, it is determined that the temporary array Tₒ is larger than B, the process may flow to block 814, where Tₒ is scanned by recursively invoking process 800, with Tₒ as the input sequence. The recursion may proceed one or more levels deep, until the temporary array at a level is not greater in size than B, so that it is scanned at bock 812 rather than follow another level of recursion.

After either block 812 or block 814, the process may flow to block 816, where a loop begins that iterates over each block of the input sequence. At block 818, a reduction value from the temporary array corresponding to the current block may be selectively propagated to elements of the current block. More specifically, if the immediately preceding block's reduction value is known to belong to the same segment, it may be combined with the elements of the current block. In one implementation, each block has a corresponding element of the temporary array that represents the reduction value of all elements preceding the block in the most recent segment. This value is combined, based on the scan operator, with each element of the current block, until a new segment begins, as determined by the flags. At an element that corresponds to a new segment boundary, propagation may be discontinued for the row. Thus, reduction values of each block may be selectively propagated to the succeeding block or portions thereof. The actions of block 818 may include copying the current block into the shared register file prior to propagation, and copying the modified block back to the global memory.

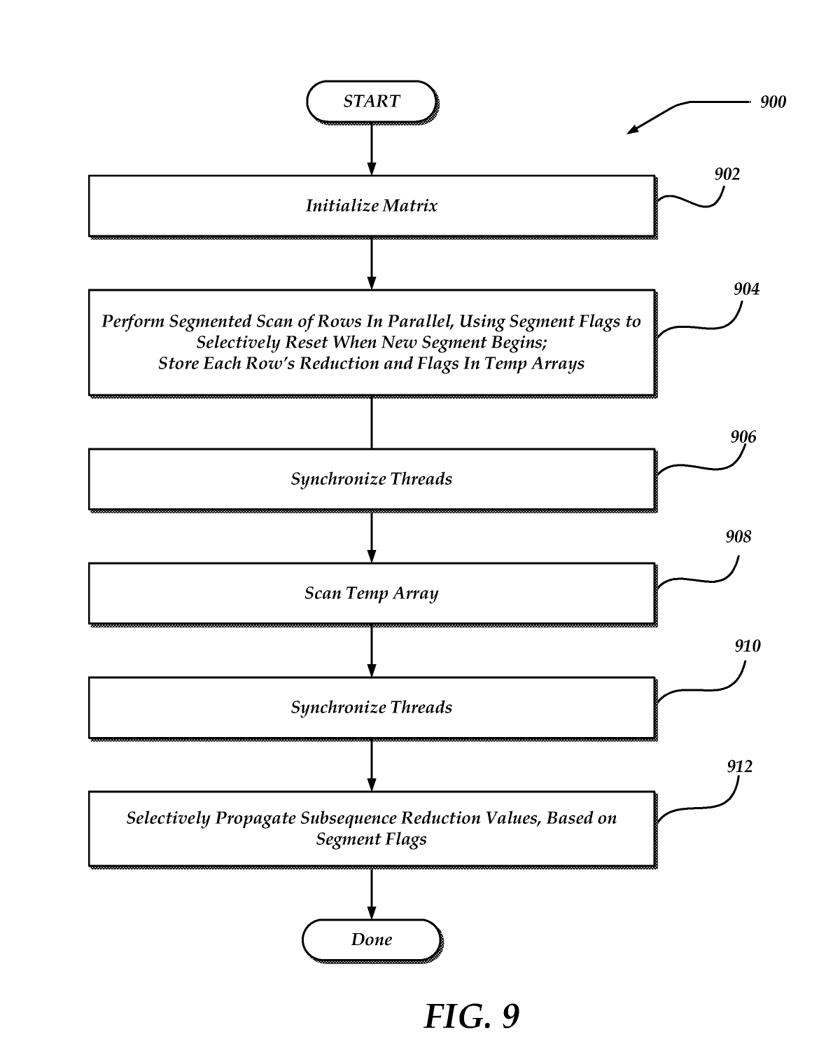

FIG. 9 is a flow diagram illustrating a process 900 for performing a segmented scan of a block of an input sequence. The process 900 employs a matrix structure to enhance the efficiency of the process when executed in conjunction with a parallel processor. Process 900, or a portion thereof, may be performed as part of the actions of blocks 806 or 812 of process 800 in FIG. 8. Process 900 may be executed on a GPU or another parallel processing system, such as the GPU of FIG. 1, and variations thereof. In one configuration, process 900 may be executed by program instructions of scan kernel 136 of FIG. 1. Process 900 is similar to process 500 of FIG. 5, and much of the discussion thereof applies to process 900.

After a start block, at block 902, initialization is performed, including determining the dimensions of a data matrix and padding intervals. This initialization may be the same as, or substantially similar to, the initialization as described in block 502 of FIG. 5 and process 600 of FIG. 6. The initialization may result in a two-dimensional matrix such as padded matrix 702 of FIG. 7. Additionally, the initialization of block 902 may include loading a vector of flags representing segment boundaries corresponding to the current block. In one implementation, the flags are packed into machine words, with one flag corresponding to each bit. In other implementations, flags may be represented in different ways, including completely unpacked.

The process may flow to block 904, where a segmented scan is performed on each row. In one implementation, this is performed in parallel for all rows of the padded matrix 702 or a subgroup thereof, with a corresponding thread performing the scan for each row. In one implementation, each thread may sequentially scan the corresponding row.

In one implementation, while performing each scan of each row, a determination may be made of whether a new segment begins at any of the elements of the row. The vector of flags representing segment boundaries may be used to make this determination. If a new segment begins, the scan may be reset to the identity value of the scan operation, thus preventing propagation of values across segments.

In one implementation, upon performing the scan of each row, a corresponding reduction value is determined. This may be the reduction value for the entire row, or the portion of the row that begins at the last segment boundary of the row. The reduction value may be placed in a temporary array at the array element corresponding to the row and thread. In one embodiment, the segmentation flags of each row are copied to a corresponding temporary flags array. In one implementation, the flags are not packed, allowing for simple or fast access. As for process 500, since each thread is performing computations on its own corresponding data, during the scan of a row group, synchronization of the threads is not needed.

After performing the parallel segmented scans at block 904, the process may flow to block 906, where thread synchronization may be performed. The process may then flow to block 908, where a segmented scan is performed on the temporary array. The scan of the temporary array may use multiple threads, or it may be performed by a single thread. In one implementation, the scan of the temporary array may use matrix scan techniques described herein. In one implementation, the scan of the temporary array may employ a parallel tree-based scan, such as illustrated in FIGS. 2A-B. The selection of which technique to use when performing a scan of the temporary array may be based on the size of the temporary array. In one embodiment, the selection of which technique to use may be based on the number of memory banks in the shared register file.

After performing the scan of the temporary array, the process may flow to block 910, where thread synchronization may be performed. The process may flow to block 912, where reduction values from the temporary array may be selectively propagated to corresponding rows. More specifically, if the immediately preceding row's reduction value is known to belong to the same segment, it may be combined with the elements of the row. In one implementation, for each element of the temporary array, the value is combined, based on the scan operator, with each element of the succeeding row, until a new segment begins, as determined by the flags. This causes reduction values to selectively propagate across rows, based on the segment configuration.

Following is a pseudocode listing, showing an implementation of process 800.

```
MatrixSegmentedScan ( ) {
  // Scan rows using H threads
  If (threadID < H) {
    T* row = &s[threadID * ((W × sizeOfElement)+pad)]; // thread row
    FlagT rowFlag = 0;
    T t = ε_{⊕}; // identity value
    res = ε_{⊕};
    for (int i = 0; i < W; ++i) { // determine reduction value of last
    segment in row
        if (row's i-th flag set) {
          res = ε_{⊕}
          rowFlag = 1;
        }
            else {
              res = res ⊕ t;
            }
          t = row[i];
          row[i] = res;
      }
      tempArray[threadID] = res; // reduction value
      tempFlagArray[threadID] = rowFlag;
    }
    synch( );
    ScanTempArray(tempArray, tempFlagArray);
    synch( );
    // Propagate reduction value
    If (threadID < H) {
      T* row = &s[threadID * ((W × sizeOfElement)+pad)]; // thread
      row
      T v = tempArray[threadID]; // value preceeding row
      int i = 0;
      while (row's i-th flag set) {
            row[i] = v ⊕ row[i];
            i++;
          }
        }
  }
```

The mechanisms of performing segmented or unsegmented scans, as described herein, may be used for any of a number of applications. These applications include lexical comparison of strings; addition of multi-precision numbers; polynomial evaluation; solving recurrences; implementation of sort algorithms, such as radix sort and quicksort; searching for regular expressions; histograms; and sparse vector matrix multiplication.

In one implementation, an optimization may be performed by determining and storing, for each block, the length of the block's first segment. This may be determined during or prior to the scanning phase. During the propagation phase, this may be used to determine whether propagation is needed for the block, and if so, how many elements require modification. For example, if the first segment begins at the block boundary, propagation is not needed and may be skipped for the block. In one implementation, a determination may be made as to whether a block falls entirely within a segment. If so, an unsegmented scan may be performed on the block; if not, a segmented scan may be performed on the block. The unsegmented scan may employ process 500 of FIG. 5, or a variation thereof.

It will be understood that each block of the flowchart illustrations of FIGS. 3, 5, 6, 8, and 9 and combinations of blocks in the flowchart illustrations, can be implemented by computer program instructions. These program instructions may be provided to a parallel processor to produce a machine, such that the instructions, which execute on the processor, create means for implementing the actions specified in the flowchart block or blocks. The computer program instructions may be executed by a parallel processor to cause a series of operational steps to be performed by the processor to produce a computer implemented process such that the instructions, which execute on the processor to provide steps for implementing the actions specified in the flowchart block or blocks. The computer program instructions may also cause at least some of the operational steps shown in the blocks of the flowchart to be performed in parallel. In addition, one or more blocks or combinations of blocks in the flowchart illustrations may also be performed concurrently with other blocks or combinations of blocks, or even in a different sequence than illustrated without departing from the scope or spirit of the invention.

The above specification, examples, and data provide a complete description of the manufacture and use of the composition of the invention. Since many embodiments of the invention can be made without departing from the spirit and scope of the invention, the invention resides in the claims hereinafter appended

What is claimed as new and desired to be protected by Letters Patent of the United States is:

1. A parallel processor-implemented method for performing a scan on a parallel processor having a shared register file divided into N memory banks, and a warp size S, based on an operator, of an input sequence having a plurality of elements, the input sequence including a block of length B, comprising:
a) generating a multi-dimensional matrix having a number of rows H, one or more (P) padding columns, and a data matrix that is a subset of the multi-dimensional matrix, the data matrix having H rows and W columns, each row having W elements of the plurality of elements, where H is relatively prime to W×sizeOfElement+P, and where sizeOfElement represents the size of each of the plurality of elements in memory bank units;
b) copying elements corresponding to the block of length B to the data matrix;
c) employing a plurality of threads to perform, in parallel, a first traversal of each row of the H rows and to determine a reduction value of each row based on the elements of the row and the operator;
d) storing the reduction value of each row to an array of reduction values;
e) performing a scan of the array of reduction values; and
f) employing the plurality of threads to perform, in parallel, a second traversal of each row of the H rows and to determine a value for each of the elements of the row, selectively propagating a reduction value of an immediately preceding row to the determined value.

2. The method of claim 1, the input sequence comprising a plurality of segments, further comprising selectively propagating the reduction value based on a segmentation boundary.

3. The method of claim 1, wherein the number of rows H is at least approximately equal to a numeric multiple of the warp size S.

4. The method of claim 1, the input sequence comprising a plurality of segments, further comprising representing a boundary of each segment as a flag in a vector of flags and selectively propagating the reduction value of the immediately preceding row based on the vector of flags.

5. The method of claim 1, further comprising selectively performing a scan of each of the rows during the first traversal, based on a number of segment boundaries in the block.

6. The method of claim 1, further comprising, selectively performing a segmented scan on the block during the first traversal, based on whether the block falls entirely within a segment.

7. A system for performing a scan of an input sequence on a parallel processor having a shared register file with N memory banks, comprising a scan kernel configured to perform actions including:
b) generating a two-dimensional matrix in the shared register file, the matrix having H rows and W data elements of the input sequence in each row;
c) traversing, in parallel, each of the H rows with a corresponding thread, storing a resulting reduction value corresponding to each row of the H rows in an array in the shared register file;
d) performing a scan of the array; and
e) performing, in parallel, a scan of each of the rows, and selectively combining a corresponding element of the array in each row scan.

8. The system of claim 7, the matrix comprising a block of data elements, the actions further comprising determining whether to combine the corresponding element of the array based on whether the block has a corresponding segment boundary.

9. The system of claim 7, wherein the two-dimensional matrix comprises a number P of padding columns such that (W×sizeOfElement)+P is relatively prime to N, where sizeOfElement represents a size of each data element in memory bank units.

10. The system of claim 7, wherein the two-dimensional matrix comprises a number P of padding columns such that (W×sizeOfElement)+P is relatively prime to N and not equal to N+1, where sizeOfElement represents a size of each data element in memory bank units.

11. The system of claim 7, further comprising a GPU comprising:
a) the shared register file, divided into N memory banks; and
b) a plurality of scalar processors configured to execute instructions of the scan kernel.

12. The system of claim 7, wherein traversing, in parallel, each row comprises sequentially traversing each row with a corresponding thread without synchronizing the threads during the traversal.

13. The system of claim 7, wherein the block of the input sequence includes one or more segments, and combining the corresponding element of the array for each row is selectively performed based on a segment boundary corresponding to the row.

14. The system of claim 7, wherein performing the reduction of each of the H rows comprises accessing elements of the two-dimensional matrix corresponding to a conflict group with a constant pitch that is not less than the number of data elements W in each row.

15. The system of claim 7, the actions further comprising creating a second two-dimensional padded matrix in the shared register file, storing the array in the second matrix, and performing, in parallel, a scan of the second matrix.

16. A parallel processor-based system for performing a scan of an input sequence of length B in a parallel processor having a shared register file divided into N memory banks, comprising:
a) matrix generation means for generating a two-dimensional matrix having a number of rows H and a number of columns W representing elements of the input sequence and a number of columns P representing padding elements;
b) first matrix traversal means for performing a first traversal of a plurality of rows of the two-dimensional matrix in parallel by a corresponding plurality of threads, each traversal determining a reduction value of the corresponding row; and
c) second matrix traversal means for performing a second traversal of the plurality of rows in parallel by the corresponding plurality of threads, selectively propagating the reduction values to the elements of the plurality of rows.

17. The system of claim 16, further comprising a GPU comprising a plurality of multiprocessors, each multiprocessor having a corresponding shared register file and providing a plurality of threads, each thread having access to the shared register file.

18. The system of claim 16, wherein first matrix traversal means and the second matrix traversal means each perform a sequential traversal of each of the plurality of rows.

19. The system of claim 16, further comprising segmentation means for determining whether to propagate the reduction values based on segment boundaries.

20. The system of claim 16, further comprising padding means for generating padding cells based on the length B, wherein the padding means generates padding cells at intervals greater than N.
